(19) United States
(12) Patent Application Publication
(10) Pub. No.: US 2007/0286971 A1
(43) Pub. Date: Dec. 13, 2007

(54) Thermochromatic compositions, thermochromatic devices, and methods for making same

(76) Inventors: Kevin Eliott Cooper, Glastonbury, CT (US); Roger John Andresen, Atlanta, GA (US)

Correspondence Address: Adam E. Crall, 5803 Cay Cove Court, Tampa, FL, 33615, US

(21) Appl. No.: 11/801,605

(22) Filed: May 10, 2007

Related U.S. Application Data
(60) Provisional application No. 60/801,531, filed on May 18, 2006.

(51) Int. Cl. F16B 5/07; B32B 37/12; B32B 9/04

(52) U.S. Cl. 428/33; 156/60; 428/332; 428/411.1

(57) ABSTRACT

Various embodiments of thermochromatic compositions and devices and methods of making thermochromatic compositions and devices are provided. One embodiment comprises a thermochromatic composition comprising: a binding material; a thermochromatic material having a first color state a first temperature and a second color state at a second temperature; and a filler material for improving the thermal conductivity of the thermochromatic composition.

### CROSS-REFERENCE TO RELATED APPLICATION

This application claims the benefit of the priority of U.S. Provisional Patent Application Ser. No. 60/801,531, entitled “Thermochromatic Compositions, Thermochromatic Devices, and Methods for Making Same” and filed May 18, 2006, which is hereby incorporated by reference in its entirety.

### BACKGROUND

There are various types of thermochromatic materials that stably change color based on changes in temperature. One type of thermochromatic material comprises thermochromatic dyes or pigments. Thermochromatic dyes or pigments may be formed from various compounds, compositions, etc. In general, the thermochromatic dyes comprise an electron-supplying coloring compound and an electron-accepting coloring compound. The thermochromatic dyes are typically added to a base substance or a binding material. The thermochromatic dye or pigment may also be microencapsulated prior to being added to the binder material. Microencapsulated thermochromatic pigments can improve the sensitivity of the thermochromatic behavior and protect the thermochromatic pigment from diffusing or contacting external chemicals that may decompose the thermochromatic pigment. Another example is thermochromatic inks (e.g., liquid crystal, leucodye, etc.) or paints in which the dye or pigment is dispersed in a suitable carrier liquid or other vehicle and applied to a target surface using application technologies, such as screen printing, printing, painting, etc.

Various different types of thermochromatic materials may be used to accommodate desired color states, temperature ranges, and activation sensitivities. In most applications, the thermochromatic materials exhibit reversible color changes, as a function of temperature. Various examples of existing thermochromatic materials, such as dyes, pigments, inks, and microencapsulated pigments and dyes are described in the following U.S. patent documents, each of which are hereby incorporated by reference in their entirety: U.S. Pat. Nos. 5,011,445, 4,720,301, 5,085,607, 6,669,765, 5,879,443, 6,494,950, and 4,028,118 and U.S. Published Patent Application Serial Nos. 2005/0014444, 2003/0087580, 2004/0229754, 2004/0077743, and 2003/0122113.

The properties of the thermochromatic materials (and any binding or carrier compositions) may be adapted to achieve various color-changing effects. For example, the thermochromatic materials may change from one color density to another color density, from one color to substantially colorless, etc. The properties of the thermochromatic materials may be designed to accommodate suitable temperature ranges. In other words, the color-changing behavior may be matched to desirable activation/triggering conditions. U.S. Pat. No. 5,011,445, which is hereby incorporated by reference in its entirety, discloses a toy set in which the thermochromatic behavior is triggered by human-body contact or by a hot/cold implement.

Despite the existence of various thermochromatic inks, paints, pigments, dyes, etc., their commercial application has been primarily limited to the field of novelty items, such as toys (U.S. Pat. Nos. 5,011,445, 5,085,607, and 6,416,853 and U.S. Published Patent Application No. 2003/0087580) and shower curtains (U.S. Published Patent Application No. 2004/0241385), or in commercially-expected, print-type applications, such as books or other print media (U.S. Published Patent Application Nos. 2005/0014444 and U.S. Pat. No. 4,720,301), product labels or wrappers (U.S. Published Patent Application Nos. 2003/0217489 and 2003/0056410), and product container level indicators (U.S. Published Patent Application No. 2003/0056587).

### SUMMARY

Various embodiments of thermochromatic compositions and devices and methods of making thermochromatic compositions and devices are provided. One embodiment comprises a thermochromatic composition comprising: a binding material; a thermochromatic material having a first color state a first temperature and a second color state at a second temperature; and a filler material for improving the thermal conductivity of the thermochromatic composition.

Another embodiment comprises a method for making a thermochromatic composition. One such method comprises: providing a binding material; and combining a thermochromatic material and a thermally-conductive filler material with the binding material.

A further embodiment comprises a floor mat for a play area. One such floor mat comprises: a generally planar support layer having a downward-facing surface and an upward-facing contact surface; and a comparatively thin thermochromatic layer on the support layer, the thermochromatic layer comprising a thermochromatic material having a first color state at a first temperature range and a second color state at a second temperature range. Another embodiment of a floor mat comprises: a generally planar thermochromatic panel member, the thermochromatic panel member comprising a thermochromatic material having a first color state at a first temperature range and a second color state at a second temperature range having a first color/temperate state and further comprising a thermally-conductive filler material for increasing the thermal conductivity of the thermochromatic panel member. A further embodiment of a floor mat comprises: a plurality of interlocking panel members, at least one of the interlocking panel members being a thermochromatic panel comprising a thermochromatic material having a first color state at a first temperature range and a second color state at a second temperature range.

### BRIEF DESCRIPTION OF THE DRAWINGS

Other aspects, advantages and novel features of the invention will become more apparent from the following detailed description of exemplary embodiments of the invention when considered in conjunction with the following drawings.

FIG. 1 is an overhead view of an embodiment of an assembled floor mat having one or more thermochromatic floor panels.

FIG. 2 is an overhead detailed view of one of the thermochromatic floor panels of the floor mat of FIG. 1.

FIG. 3 is a state diagram illustrating an embodiment of the thermochromatic properties of the thermochromatic floor panels of FIGS. 1 and 2.

FIG. 4 is a graph illustrating another embodiment of the thermochromatic properties of the thermochromatic floor panels of the FIGS. 1 and 2.

FIGS. 5a-5c are a series of a partial perspective views of one of the thermochromatic floor panels of FIGS. 1 and 2 in which a thermochromatic state change is triggered via body temperature by a person's hand.

FIGS. 6a-6c are a series of a partial perspective views of one of the thermochromatic floor panels of FIGS. 1 and 2 in which a thermochromatic state change is triggered via friction by a person's shoes.

FIGS. 7a-7c are a series of a partial perspective views of one of the thermochromatic floor panels of FIGS. 1 and 2 in which a thermochromatic state change is triggered via a writing implement.

FIG. 8 is a side perspective view of an embodiment of a thermochromatic composition that may be implemented in the thermochromatic floor panels of FIGS. 1 and 2 (or other thermochromatic products, devices, systems, etc.).

FIG. 9 is a side perspective view of another embodiment of a thermochromatic composition that may be implemented in the thermochromatic floor panels of FIGS. 1 and 2 (or other thermochromatic products, devices, systems, etc.).

FIG. 10 is a block diagram illustrating an embodiment of a method for making a thermochromatic film/laminate for use with a support layer.

FIG. 11 is a block diagram illustrating an embodiment of a method for making a thermochromatic composition.

### DETAILED DESCRIPTION

This document discloses various embodiments of unique thermochromatic compositions, thermochromatic devices, and methods of making thermochromatic compositions and devices.

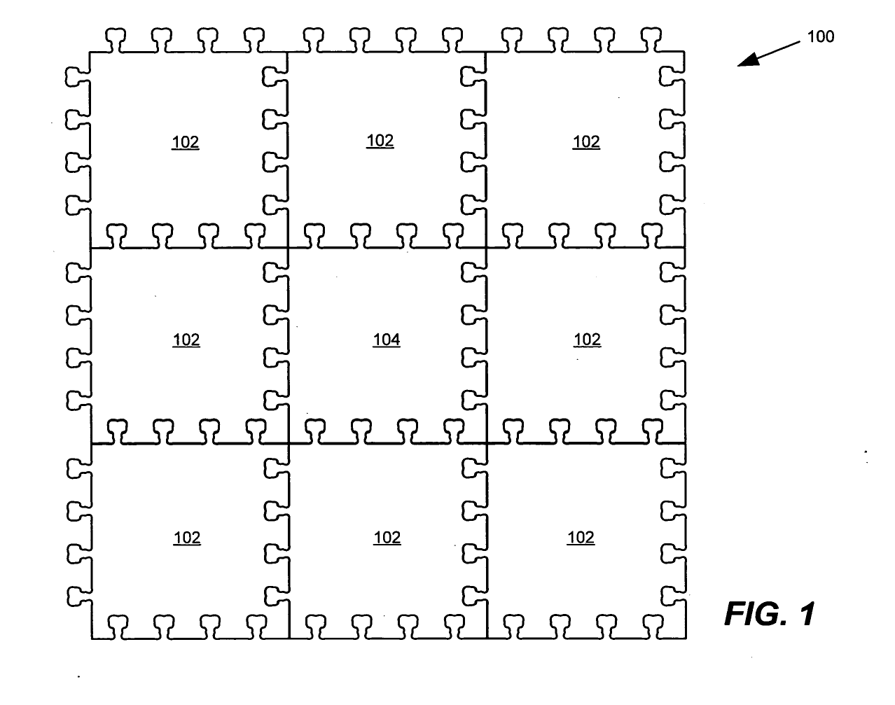

One embodiment of a thermochromatic device is illustrated in FIG. 1. FIG. 1 illustrates an assembled floor mat 100. Floor mat 100 comprises a plurality of interlocking floor panels 102 that are assembled in a generally square configuration (although other shapes and sizes may be designed as desired by the user). Floor panels 102 are designed in a modular fashion so that they may be easily attached to each other to assemble floor mat 100. One of ordinary skill in the art will appreciate that floor panels 102 may be manufactured in various sizes (e.g., length, width, thickness) and shapes, from various compositions, and using various manufacturing methods.

At least one of the panels 102 comprises a thermochromatic floor panel 104 that reversibly changes color based on temperature. Floor mat 100 may be packaged as a set of panels 102, with one or more thermochromatic floor panels 104. In one embodiment, each of the floor panels comprises a thermochromatic floor panel 104. However, in alternative embodiments, less than all of the floor panels may be thermochromatic. For example, it may be desirable to reduce the overall manufacturing cost of floor mat 100 by reducing the number of floor panels 102 that need to be configured as a thermochromatic floor panel, while maintaining the unique concept of a floor mat with thermochromatic properties. In the “island” configuration illustrated in FIG. 1, a single thermochromatic floor panel 104 is located in the middle position of floor mat 100. It should be appreciated that the location of thermochromatic floor panel(s) 104 within an assembled floor mat 100 may be a matter of user choice.

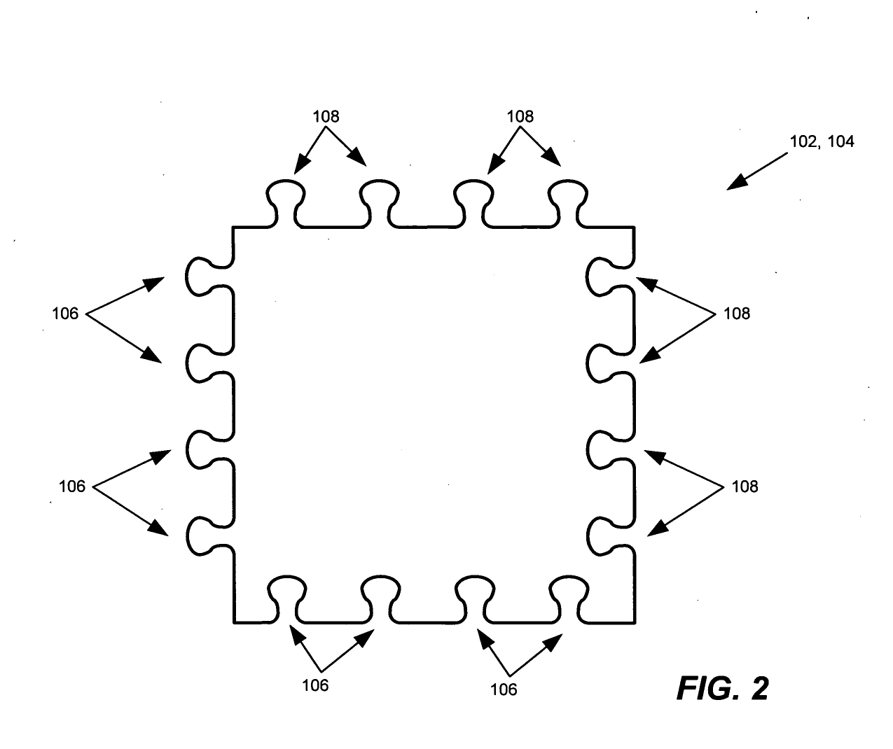

FIG. 2 illustrates a more detailed view of a single floor panel (non-thermochromatic floor panel 102 or thermochromatic floor panel 104). As mentioned above, floor panels 102 and 104 are adapted to interlock with each other in such a manner to provide a modular, flexible design methodology for floor mat 100. In the embodiment illustrated in FIG. 2, floor panels 102 and 104 comprise a generally square, planar member having pairs of interlocking opposing sides. For example, one of the opposing sides in each pair may comprise a plurality of extending members 106, while the other of the opposing sides may comprise a plurality of receiving members 108. Along the edge of each pair of opposing sides, receiving members 108 and extending members 106 are spaced and aligned relative to each other so that extending members 106 along one side of a first floor panel 102 will interlock or otherwise mate or engage with receiving members 106 along one side of a second floor panel 102. It should be appreciated that extending members 106 and receiving members 108 may be implemented in various ways, with different shapes, sizes, structural configurations, etc.

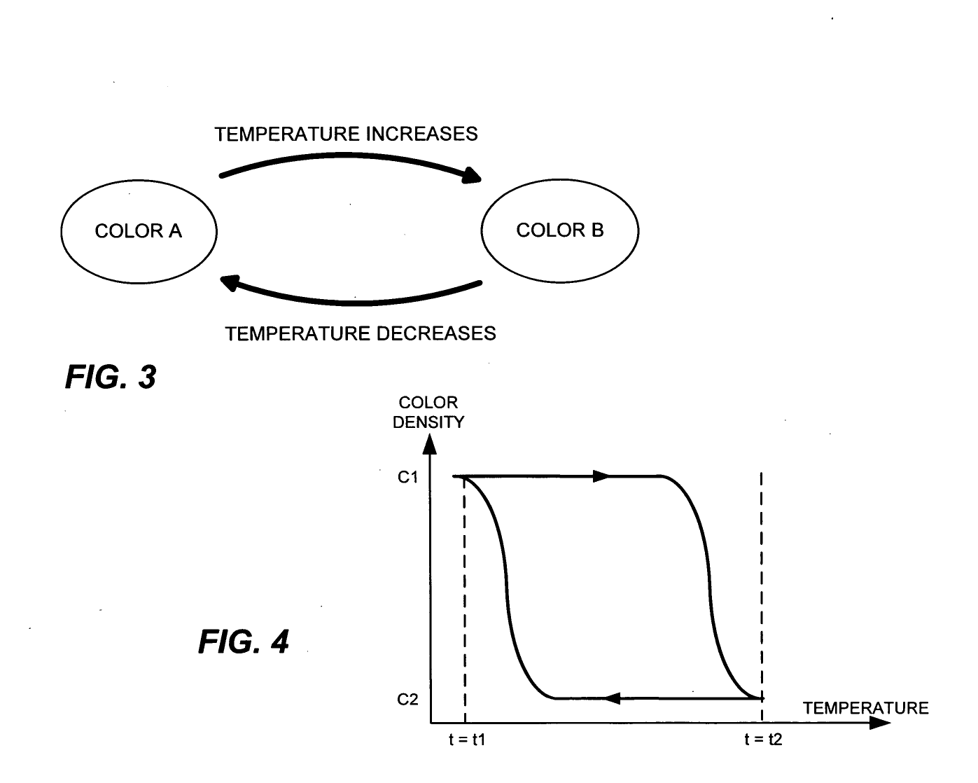

As described in more detail below, thermochromatic floor panels 104 comprise a thermochromatic material that changes color based on temperature. Generally, the thermochromatic material has a first color state (color A—FIG. 3) at a first temperature range and a second color state (color B—FIG. 3) at a second temperature range. In the first temperature range, the thermochromatic material is in the first color state. As the temperature increases and reaches an activation or trigger temperature corresponding to the second temperature range (e.g., t2 in FIG. 4), the thermochromatic material transitions to the second color state. It should be appreciated that the thermochromatic material may be adapted to effectuate two or more color changes. In this regard, the thermochromatic material(s) may have two or more color/temperature states. For example, in one embodiment, three or more color/temperature states may be accomplished by adding adding two or more thermochromatic materials to the same binding agent. Each thermochromatic material may have a particular temperature range in which it would transition from one color to another, colored to colorless, etc. By way of example, one thermochromatic material may comprise a 28 degrees Celsius red and another may comprise a 30 degrees Celsius blue. These two thermochromatic materials may be combined in the same binding agent. In this embodiment, at 25 degrees Celsius both the red and blue thermochromatic materials would be fully colored and the overall color would appear purple. As the temperature rises above 28 degrees Celsius, the red thermochromatic material would become colorless and the overall color would appear blue. Above 30 degrees Celsius the blue thermochromatic material would become colorless and the overall color would appear clear, revealing the underneath color and/or image.

Referring to FIG. 4 (which shows two states), a first color state may correspond to a higher color density, and the second color state may correspond to a lower color density (e.g., substantially colorless). When the temperature decreases and reaches an activation or trigger temperature corresponding to the first temperature range (e.g., t1 in FIG. 4), the thermochromatic material returns to the first color state. It should be appreciated that the colors, color transitions, temperature ranges, activation temperatures, and temperature sensitivities may be predefined for any suitable application. In one embodiment, the thermochromatic properties are predefined so that the thermochromatic material is in the first color state at room temperature, and the second color state is activated by a slight increase above room temperature. For instance, the thermochromatic material may be in the first color state at least at approximately 23-25 degrees Celsius, and then change to the second color state at approximately 29-31 degrees Celsius.

In embodiments in which the second color state is substantially colorless, thermochromatic floor panel 104 may further include “hidden” images that are revealed when the thermochromatic material transitions from the higher color density to substantially colorless. Floor mat 100 may be supplied with any desirable images based on the location of the floor mat. For example, floor mat 100 may be targeted as an interactive floor mat for a children's play area. In this embodiment, the “hidden” images may be selected to promote an educational or entertaining environment for children, including alpha-numeric characters, images, a footprint or solid trail, or other licensed images, to name a few.

The thermochromatic material may comprise any currently available or later-developed material exhibiting color-changing properties. In one embodiment, the thermochromatic material comprises a thermochromatic dye or pigment (e.g., a leucodye, liquid crystal). The thermochromatic dye or pigment may be incorporated into a suitable binding material. The binding material comprise a binding agent, a polymer matrix, or other desirable supporting material. The thermochromatic dye or pigment may be incorporated into applicable manufacturing processes. For instance, the thermochromatic dye or pigment may be added to an existing master batch, powder, etc. of a manufacturing process in suitable volume and/or weight proportions. For thin layers (e.g., approximately less than one millimeter in thickness), one suitable mixing ration may correspond to between 10 and 20 weight percent of the final weight. For thicker layers (e.g., greater than 1 mm in thickness), less weight percent of thermochromatic master batch may be used, ranging from 5-10 weight percent based on the color density of the particular dye. In other embodiments, the thermochromatic dye or pigment is dispersed in microencapsules. It should be further appreciated that, when implemented as an ink or paint, the thermochromatic material may be applied to the upper surface of the floor panel surface using, for example, screen, flexo, air brushed, or heat transferred printing processes.

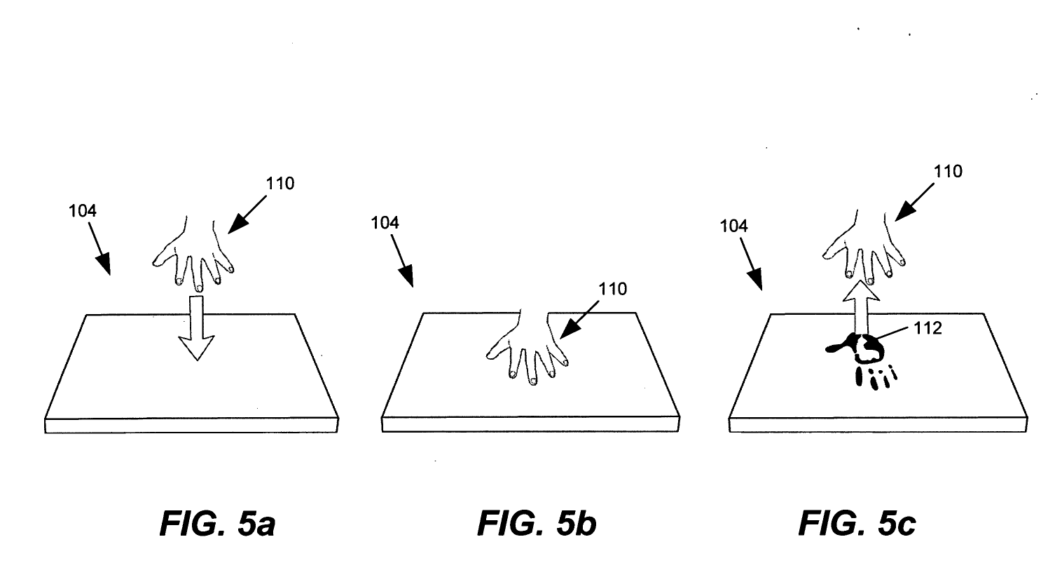

The properties of the thermochromatic material and floor panel 104 may be adapted to accommodate various types of activation or triggering mechanisms. Referring to FIGS. 5a-5c, in one embodiment, the thermochromatic material transitions to the second color state in response to human body temperature activation. At room temperature (e.g., 23-25 degrees Celsius), thermochromatic floor panel 104 is in the first color/temperature state (e.g., a high color density—FIG. 5a). When a substance (e.g., a hand 110, an arm, or other exposed skin) contacts the upper surface of thermochromatic floor panel 104 (FIG. 5b), the temperature of the thermochromatic material increases and, at the trigger/activation temperature, transitions to the second color/temperature state (e.g., a lower density color, substantially colorless, etc.). As illustrated in FIG. 5c, when hand 110 is removed, the area of thermochromatic floor panel 104 that reaches the trigger/activation temperature changes color, leaving an imprint 112.

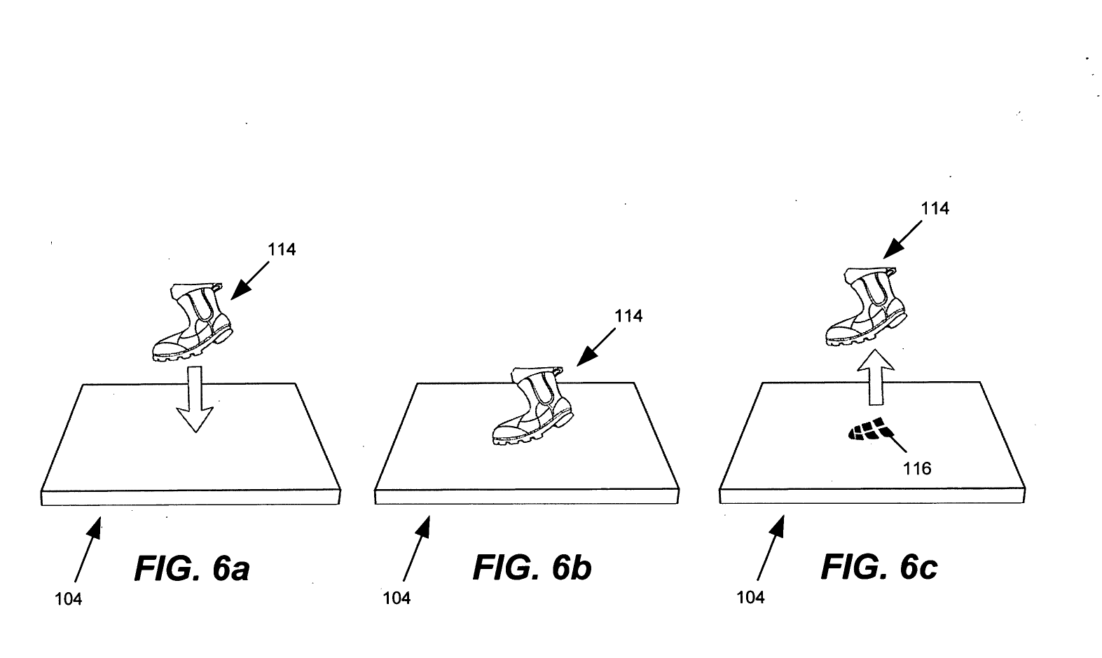

In the embodiment of FIGS. 6a-6c, the second color/temperature state is triggered at another predefined temperature above room temperature. In this embodiment, the thermochromatic properties may be designed so the color/temperature state transition occurs as a result of, for example, friction resulting from a user walking on the upper surface of the thermochromatic floor panel. At room temperature, thermochromatic floor panel 104 is in the first color/temperature state (FIG. 6a). When a substance (e.g., a shoe 114, a hand, a writing implement, etc.) makes frictional contact with the upper surface of thermochromatic floor panel 104 (FIG. 6b), the temperature of the thermochromatic material increases and, at the trigger/activation temperature, transitions to the second color/temperature state, leaving an imprint 116 (FIG. 6c).

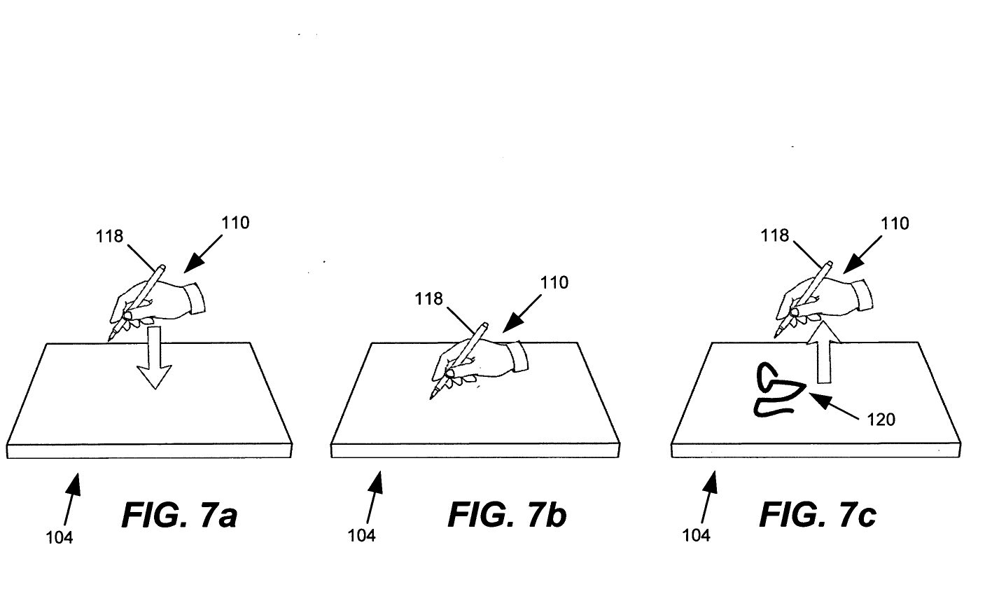

FIGS. 7a-7c illustrate another embodiment in which the color/temperature state transition is triggered via a writing implement 118. It should be appreciated that writing implement 118 may be adapted to trigger the transition with frictional contact, as described relative to FIGS. 6a-6c, through a heat transfer process similar to FIGS. 5a-5c, or through a heating or cooling mechanism in the pen itself.

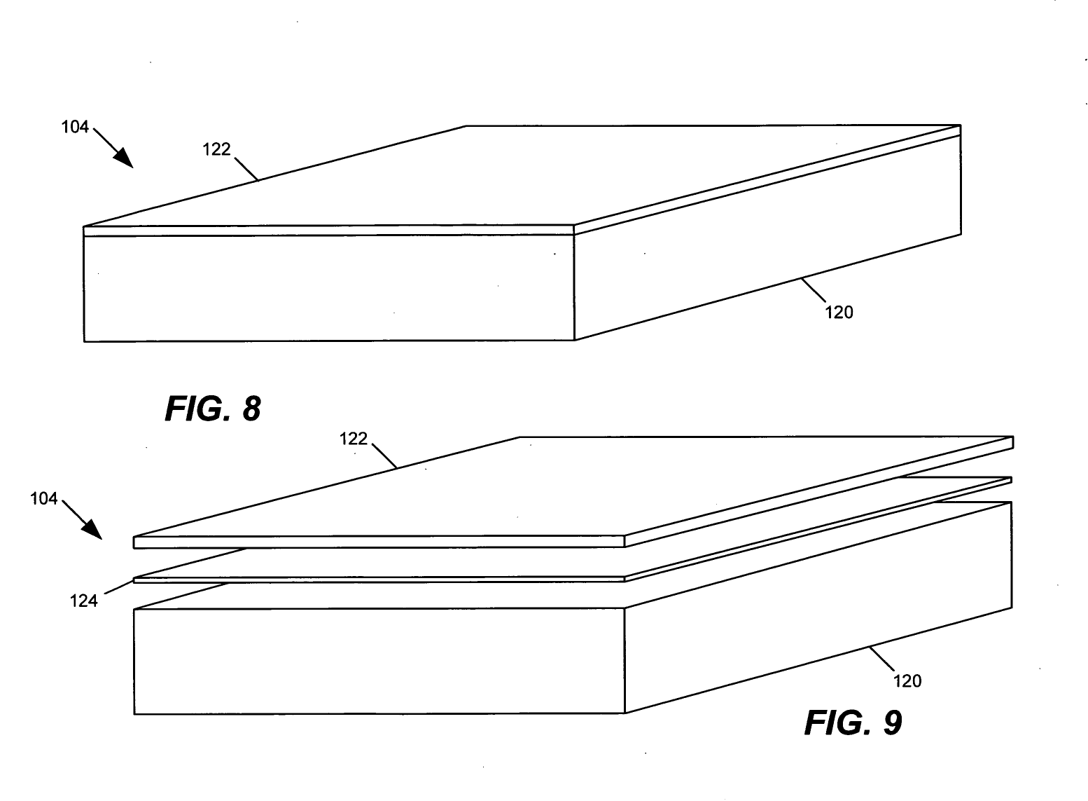

Thermochromatic panel member 104 may be manufactured in various ways. Referring to FIG. 8, in one embodiment, thermochromatic panel member 104 comprises a support layer 120 and a thermochromatic layer 122. Support layer 120 comprises a generally planar member having an upper surface and a lower surface. In operation, the lower surface comprises a floor-abutting surface. Support layer 120 may be formed from various compositions. In one embodiment, support layer 120 comprises an ethyl vinyl acetate (EVA) foam. In another embodiment, support layer 120 comprises a polyurethane foam. One of ordinary skill in the art will appreciate that other suitable support compositions may be used, including, for example, rubber, neoprene, and other aerated foams. Although floor panels 102 may have any desirable dimensions, one example of a floor mat 100 for a children's play area uses 60 cm×60 cm floor panels 102 having a thickness of approximately 9-11 mm.

As illustrated in FIG. 8, thermochromatic layer 122 may comprise a comparatively thin film, laminate, etc. disposed on the upper surface of support layer 120. Thermochromatic layer 122 may be disposed on only a portion of the upper surface of support layer 122. In this configuration, thermochromatic layer 122 comprises a contact surface of floor mat 100. In alternative embodiments, thermochromatic layer 122 may be disposed on only a portion of the upper surface of support layer 120, on locations where it is desirable to have the thermochromatic feature. Thermochromatic layer 122 may comprise any of the thermochromatic materials described above (e.g., thermochromatic pigments, dyes, inks, microencapsulates, etc.), and may be applied to support layer 120 in a number of different ways. Where thermochromatic layer 122 comprises an ink or paint, for example, it may be applied to the upper surface using a screen printing, or other, process. In other embodiments, thermochromatic layer 122 may be adhered to the upper surface of support layer 120. As illustrated in FIG. 9, an adhesive 124 may be used to adhere thermochromatic layer 122 to support layer 120. In alternative embodiments, thermochromatic layer 122 may be blown, printed or extruded onto support layer 120, thermoset, or otherwise disposed on the upper surface using any desirable manufacturing process, including, for example, pressure sensitive laminates. In alternative embodiments, thermochromatic layer 122 may be sandwiched between to support layers for protection and better adhesion.

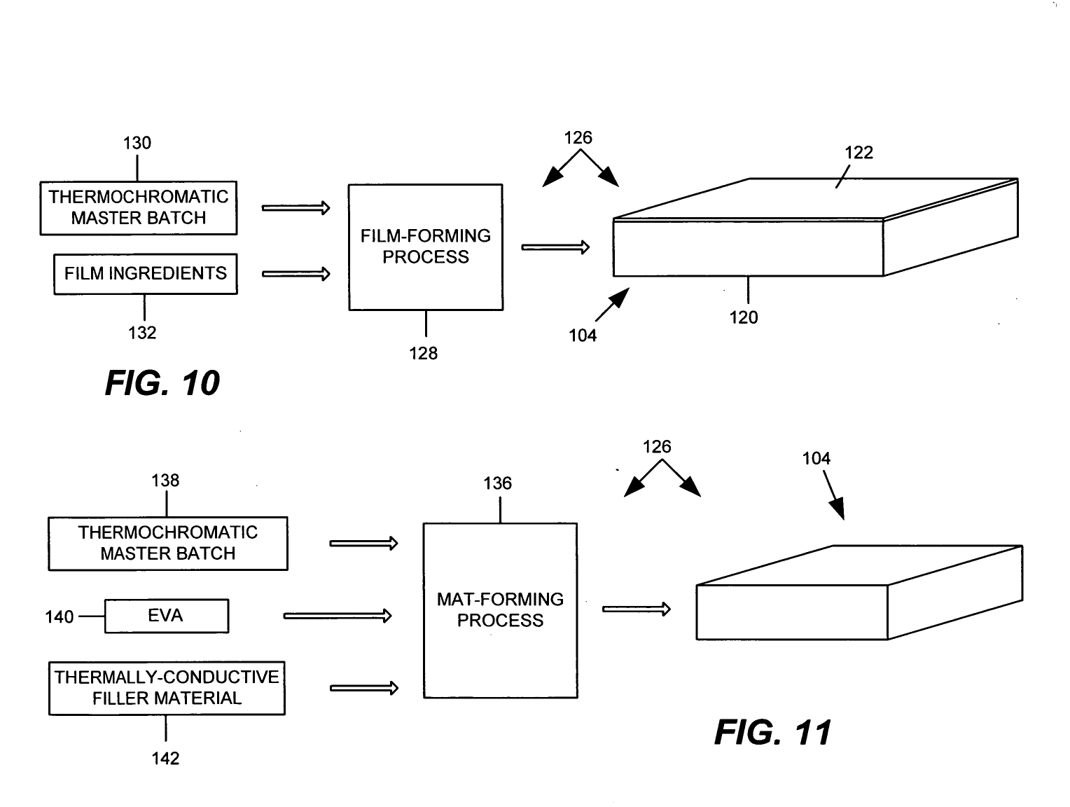

As mentioned above, the thermochromatic material of thermochromatic layer 122 may be combined with suitable carrier materials, binding materials, etc. In one embodiment, thermochromatic layer 122 comprises a comparatively thin (approximately 20 mils) ethylene vinyl acetate (EVA) film or laminate or low density polyethyle film. For example, FIG. 10 illustrates a method 126 for making thermochromatic layer 122. Thermochromatic layer 122 is manufactured by mixing thermochromatic material 130 with appropriate ingredients 132 for the laminate or film. It should be appreciated that the film or laminate ingredients may comprise various suitable compositions, including, for example, polyurethane and polyvinyl chlorides (PVC). The mixture undergoes an appropriate manufacturing process (thermochromatic layer-forming process 128—FIG. 10). In this regard, it should be appreciated that thermochromatic materials 130 and film ingredients 132 may be mixed in desirable volume/weight proportions at appropriate temperatures. As mentioned above, for thin layers (e.g., approximately less than one millimeter in thickness), one suitable mixing ration may correspond to between 10 and 20 weight percent of the final weight. For thicker layers (e.g., greater than 1 mm in thickness), less weight percent of thermochromatic master batch may be used, ranging from 5-10 weight percent based on the color density of the particular dye.

FIG. 11 illustrates an embodiment of a thermochromatic composition and a method for manufacturing same. The thermochromatic composition may be used to form thermochromatic floor panels 104, although it should be appreciated that it may be universally applied to other products, devices, structures, layers, etc. The thermochromatic composition comprises thermochromatic material 138, a binding material, and a thermally-conductive filler material 142. The binding material may comprise a binding agent, polymer matrix, etc. In one particular embodiment, the binding material comprises ethylene vinyl acetate (EVA). It should be appreciated that thermochromatic material 138 may be also be combined with other carrier materials, such as, for example, finishing materials, liquids, paints, etc. In this regard, it should be further appreciated that thermally-conductive filler material 142 may be added to any combination of thermochromatic material 138 and binding material, carrier material, etc.

Thermally-conductive filler material 142 generally comprises a material for increasing the thermal conductivity of the thermochromatic composition. By increasing the thermal sensitivity of the product or substrate, the activation or triggering conditions of thermochromatic material 138 may be improved. It should be appreciated that thermochromatic compositions with thermally-conductive filler material 142 may be desirable in a number of commercial applications. For instance, thermally-conductive filler material 142 may reduce the amount of time required to effectuate the thermochromatic response. Thermally-conductive filler material 142 may also reduce the amount of time and/or type of contact required to effectuate the thermochromatic response. It may be advantageous to employ a thermochromatic composition with thermally-conductive filler material 142 in toys, for example, to enable minimal contact with a temperature gradient. In another example, such thermochromatic compositions may be used in a baseball pitching training aid, product, etc. A strike zone may be provided on a surface of the thermochromatic device. Thermally-conductive filler material 142 may enable a thrown ball striking the surface of the thermochromatic device to effectuate a thermochromatic response under very restrictive contact/time conditions, thereby providing feedback to the user as to where the ball contacted the surface relative to the strike zone. In another sports training-type application, a golf club or baseball bat (or a thermochromatic add-on for the club or bat) may be designed so that a thermochromatic response is triggered at the surface of the club/bat (or thermochromatic add-on) where contact with the ball is made. The thermochromatic response of floor mat 100 may be improved with the addition of thermally-conductive filler material 142. In this regard, the thermochromatic response may be triggered more quickly, as a child moves across the surface of the floor mat. Another advantageous commercial application may involve the use of the thermochromatic compositions for a waterslide. The thermochromatic properties may be enhanced with thermally-conductive filler material 142 so that a thermochromatic response is triggered, with minimal friction, as the user slides across the surface of the waterslide. It should be further appreciated that thermochromatic compositions comprising thermally-conductive filler material 142 may be applied to any other desirable products, devices, etc. It may be particularly desirable for applications that use thicker thermochromatic materials to improve heat diffusion through the through the object. Furthermore, thermally-conductive filler material 142 may promote a larger and more uniform color-changing area. In exemplary embodiments, thermally-conductive filler material 142 may comprise, for example, carbon fiber, metallic additives, or powders (e.g., nanotube powders). One of ordinary skill in the art will appreciate that other suitable compositions may be used.

FIG. 11 also illustrates a method 134 for making the thermochromatic composition. Thermochromatic material 138, the binding material (e.g., EVA), and thermally conductive filler material 142 are mixed together. The mixture undergoes an appropriate manufacturing process 136. The ingredients may be mixed in any desirable volume/weight proportions at appropriate temperatures, depending on particular properties of the materials and characteristics of manufacturing process 136. In one embodiment, thermochromatic material 138 may comprise approximately between 10 and 20 weight percent of the final weight. In another embodiment, thermochromatic material 142 may comprise less weight percent, ranging from approximately 5-10 weight percent based on the color density of thermochromatic material. In one of a number of possible implementations, thermally-conductive filler may material 142 may comprise between approximately 30 and 70 weight percent of the final weight. It should be appreciated, that the particular percentages may depend on, for example, the aspect ratio of the filler material, the type of filler material, etc. For instance, in an embodiment in which thermally-conductive filler material 142 comprises high-pitch carbon, it may comprise approximately 40 weight percent. Manufacturing process 136 may be designed to accommodate the particular properties of thermochromatic material 138, thermally-conductive filler material 142, and/or the binding material. By way of example, for certain types of materials it may be desirable to control the process temperature(s) to prevent material decomposition. When implementing certain thermochromatic materials, it may be desirable to keep temperatures below, for example, 440 degrees Fahrenheit to prevent decomposition of the thermochromatic material.

Although this disclosure describes the invention in terms of exemplary embodiments, the invention is not limited to those embodiments. Rather, a person skilled in the art will construe the appended claims broadly, to include other variants and embodiments of the invention, which those skilled in the art may make or use without departing from the scope and range of equivalents of the invention.

What is claimed is:

1. A floor mat for a play area, the floor mat comprising:
a generally planar support layer having a downward-facing surface and an upward-facing contact surface; and
a comparatively thin thermochromatic layer on the support layer, the thermochromatic layer comprising a thermochromatic material having a first color state at a first temperature range and a second color state at a second temperature range.

2. The floor mat of claim 1, wherein the second color is substantially colorless and the second temperature range is approximately between 29 and 31 degrees Celsius.

3. The floor mat of claim 1, wherein the second color is substantially colorless and the second temperature range is predefined to accommodate body temperature activation.

4. The floor mat of claim 1, wherein the thermochromatic material comprises one of a thermochromatic dye, a thermochromatic ink, and microencapsulated thermochromatic ink.

5. The floor mat of claim 1, wherein the thermochromatic material is printed on the upward-facing contact surface of the support layer.

6. The floor mat of claim 1, wherein at least a portion of the edges of the support layer comprise an interlocking mechanism.

7. The floor mat of claim 1, wherein the thermochromatic material is sandwiched between two protective layers.

8. The floor mat of claim 1, wherein the thermochromatic layer has a cross-sectional thickness of less than approximately 20 mil.

9. A method for making a thermochromatic composition, the method comprising:
providing a binding material; and
combining a thermochromatic material and a thermally-conductive filler material with the binding material.

10. The method of claim 9, wherein the binding material comprises a polymer matrix.

11. The method of claim 9, wherein the thermochromatic material comprises a reversible thermochromatic pigment.

12. The method of claim 9, wherein the thermally-conductive filler comprises one of metallic additive, a powder, and a carbon fiber.

13. The method of claim 9, wherein the thermally-conductive material comprises between 30 and 70 weight percent.

14. The method of claim 9, wherein the thermally-conductive material comprises approximately 40 weight percent.

15. The method of claim 9, wherein the combining the thermochromatic material and the thermally-conductive filler material with the binding material comprises adding between 30 and 70 weight percent of the thermally-conductive material.

16. The method of claim 9, further comprising forming the thermochromatic composition into a predefined structure.

17. The method of claim 9, wherein the predefined structure comprises a generally planar floor mat.

18. A floor mat comprising a plurality of interlocking panel members, at least one of the interlocking panel members being a thermochromatic panel comprising a thermochromatic material having a first color state at a first temperature range and a second color state at a second temperature range.

19. The floor mat of claim 18, further comprising an associated writing implement for activating the thermochromatic material from one of the first and second color states to the other of the first and second color states.

20. The floor mat of claim 18, wherein the thermochromatic panel further comprises a thermally-conductive filler material and a binding material mixed with the thermochromatic material.
